(19) United States
(12) Patent Application Publication
(10) Pub. No.: US 2016/0150398 A1
(43) Pub. Date: May 26, 2016

(54) WEARABLE DEVICE, PORTABLE DEVICE AND ASSOCIATED CONTROL METHOD

(71) Applicant: MEDIATEK INC., Hsin-Chu (TW)

(72) Inventors: Shih-Chieh Huang, New Taipei City (TW); Chih-Hsiang Hsiao, Taipei City (TW)

(21) Appl. No.: 14/552,490

(22) Filed: Nov. 25, 2014

(51) Int. Cl. H04W 8/22

(52) U.S. Cl. CPC H04W 8/22

(57) ABSTRACT

A wearable device includes a plurality of sensors, a wireless communication unit and a control unit. The wireless communication unit is arranged for communicating with an electronic device having a plurality of sensors. The control unit is arranged for receiving at least one sensed data from the electronic device via the wireless communication unit, and comparing the at least one sensed data of the electronic device with sensed data generated by at least one of the sensors of the wearable device to generate a comparison result, and determining whether the electronic device is in a aware status according to the comparison result.

### BACKGROUND

To confirm that an electronic device such as a cell phone is under a user's control, prior art uses a single sensor of the electronic device to determine whether the electronic device is under a user's control. For example, a proximity-based or a location-based control method such as Global Positioning System (GPS) may be used to judge if the electronic device is far from the user. However, distance does not always imply that the electronic device is out of user's control; and an accelerometer may be used if the electronic device is leaving the user (e.g. the electronic device is falling to the ground). For example, the electronic device may generate false alarm when the user jumps from higher level to lower level. Therefore, how to accurately determine whether the electronic device is belonging to the user is an important topic.

### SUMMARY

It is therefore an objective of the present invention to provide a wearable device, a portable device, and an associated control method, which can accurately determine whether the electronic device is under user's control, to solve the above mentioned problem.

According to one embodiment of the present invention, a wearable device comprises a plurality of sensors, a wireless communication unit and a control unit. The wireless communication unit is arranged for communicating with an electronic device having a plurality of sensors. The control unit is arranged for receiving at least one sensed data from the electronic device via the wireless communication unit, and comparing at least one sensed data of the electronic device with sensed data generated by at least one of the sensors of the wearable device to generate a comparison result, and determine whether the electronic device is in an aware status or not according to the comparison result.

According to another embodiment of the present invention, a control method of a portable device comprises: obtaining sensed data from at least one sensor of the portable device; receiving at least one data from an electronic device; comparing the at least one sensed data of the electronic device with the sensed data of the portable device to generate a comparison result; and determine whether the electronic device is in a aware status or not according to the comparison result.

According to another embodiment of the present invention, a portable device comprises a plurality of sensors, a wireless communication unit for communicating with an electronic device having a plurality of sensors, and a control unit. The control unit compares at least one sensed data of the electronic device with sensed data generated by at least one of the sensors of the portable device; and the control unit generates a control signal representing that the at least one sensed data of the electronic device and the sensed data generated by at least one of the sensors of the portable device are synchronous or asynchronous.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a wearable device according to one embodiment of the present invention.

FIG. 2 is a diagram illustrating operations of the wearable device and the electronic device when electronic device is left in a car according to one embodiment of the present invention.

FIG. 3 is a diagram illustrating operations of the wearable device and the electronic device when electronic device is left on a bus.

FIG. 4 is a diagram illustrating operations of the wearable device and the electronic device when the electronic device is falling on the ground.

FIG. 5 is a diagram illustrating operations of the wearable device and the electronic device when the wearable device and the electronic device are at home.

FIG. 6 is a diagram illustrating operations of the wearable device and the electronic device when it is in a device discovery process.

FIG. 7 is a flowchart of a control method of a portable device according to one embodiment of the present invention.

FIG. 8 is a flowchart of a control method of a portable device according to another embodiment of the present invention.

### DETAILED DESCRIPTION

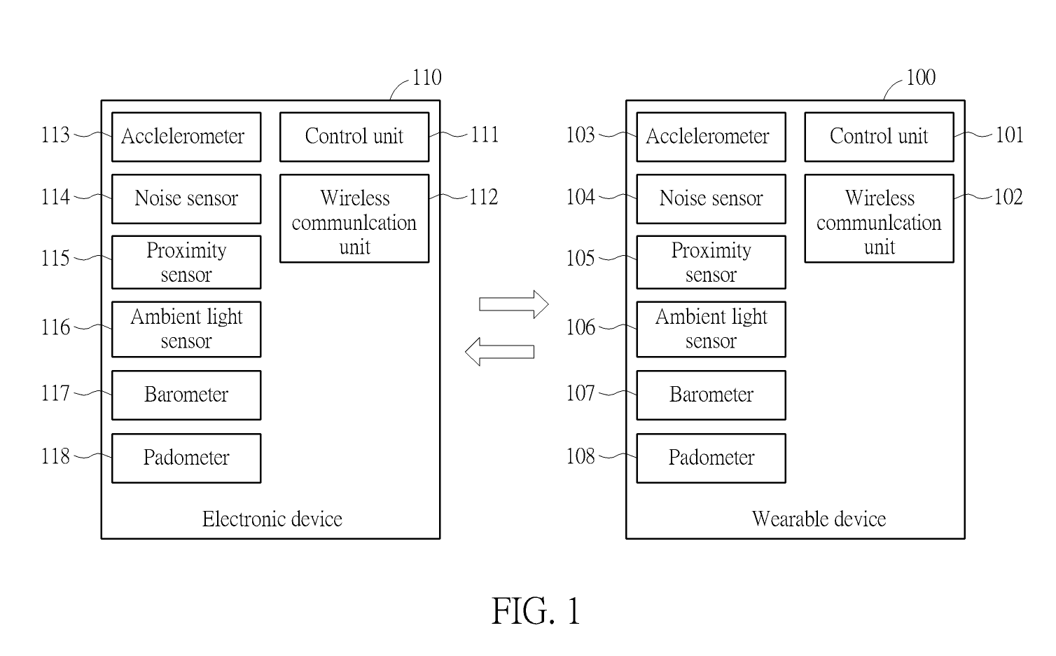

Please refer to FIG. 1, which is a diagram illustrating a wearable device 100 according to one embodiment of the present invention. As shown in FIG. 1, the wearable device 100 comprises a control unit 101, a wireless communication unit 102 and a plurality of sensors such as an accelerometer 103, a noise sensor 104, a proximity sensor 105, an ambient light sensor 106, a barometer 107 and a pedometer 108. In this embodiment, the wearable device 100 can be activity tracker, smart watch, smart glasses or any other wearable device. In addition, the sensors mentioned in FIG. 1 are for illustrative purposes only, in other embodiments of the present invention, other sensors may be added into the wearable device 100, or a portion of the sensors 103-108 may be removed from the wearable device 100. In addition, the control unit 101 can be a processor, or any (dedicated) circuit, and the wireless communication unit 102 may include an antenna and associated interface circuit.

The wearable device 100 is arranged for determining whether an electronic device 110 is in an aware status of the wearable device, where the aware status can be defined as that a user is aware of and capable of controlling the electronic device 110. For example, when the user wearing the wearable device 100 at home, because the user should control the electronic device 110 as long as the wearable device 100 is in the house, at this time the aware status may be an aware zone inside the whole house; and when the user is outdoors, the aware status may be an aware zone near the user. As shown in FIG. 1, the electronic device 110 comprises a control unit 111, a wireless communication unit 112 and a plurality of sensors such as an accelerometer 113, a noise sensor 114, a proximity sensor 115, an ambient light sensor 116, a barometer 117 and a pedometer 118. In this embodiment, the electronic device 110 can be a cell phone, a tablet or any other portable electronic device, and at least a portion of sensors of the electronic device 110 are the same as the sensors of the wearable device 100.

The electronic device 110 may periodically transmit sensed data sensed by at least one of the sensors 113-118 to the wearable device 100 via the wireless communication unit 112 and 102, and the control unit 101 may compare the sensed data of the electronic device 110 with sensed data generated by at least a portion of the sensors 103-108 to generate at least one comparison result, and the control unit 101 may determine whether the electronic device 110 is in the aware status to the wearable device 100. In detail, the electronic device 110 may periodically transmit the sensed data of the accelerometer 113, the noise sensor 114, the proximity sensor 115, the ambient light sensor 116, the barometer 117 and the pedometer 118 to the wearable device 100, and the control unit 101 compares the sensed data of the accelerometer 113 with the sensed data of the accelerometer 103 to generate a first comparison result, compares the sensed data of the noise sensor 114 with the sensed data of the noise sensor 104 to generate a second comparison result, compares the sensed data of the proximity sensor 115 with the sensed data of the proximity sensor 105 to generate a third comparison result . . . . Each comparison result indicates that whether the sensed data sensed by the sensor of the wearable device 100 and the sensed data sensed by the sensor of the electronic device 110 is synchronous or asynchronous. Then, the control unit 101 determines whether the electronic device 110 is in the aware status of the wearable device 110 or not according to at least one of the comparison results. When it is determined that the electronic device 110 is not in the aware status, the wearable device 110 may notify the user by vibration or audible alarm or flash. In addition, when it is determined that the electronic device 110 is not in the aware status, the wearable device 110 may also transmit a control signal to the electronic device 110 to trigger the electronic device 110 to notify the user by vibration or audible alarm or flash. Thus, the user can find the electronic device 110 easy.

Because the wearable device 100 and the electronic device 110 locate nearby the same user, the sensed data of the sensors 113-118 of the electronic device 110 and the sensed data of the sensors 103-108 of the wearable device 100 should be synchronous (i.e. a degree or a variation of sensed data of the electronic device 110 is similar to that of the sensed data of the wearable device 100). Therefore, by using the above-mentioned method, the wearable device 100 can immediately and accurately notify the user when the electronic device 110 is not in the aware status.

It is noted that the sensors illustrated in the wearable device 100 and the electronic device 110 are just for taking example, not for limitations. The sensors in the wearable device 100 can be different from the sensors in the electronic device 110, and the aware status can also be determined by scenario algorithms. For example, a GPS (Global Positioning System) of the electronic device 110 determines that the user is at a tropical area in warm weather, but a temperature sensor of the wearable device 100 senses a cold temperature. Therefore, the sensed data sensed by the sensor of the wearable device 100 and the sensed data sensed by the sensor of the electronic device 110 is asynchronous, and the user can find either the wearable device 100 or the electronic device 110 is not around the user himself.

Moreover, the scenario algorithms can be implemented not only by sensor. For example, if a calendar event in the electronic device 110 shows the user is in a library, but the noise sensor 114 of the wearable device 100 determines that the user is in a noisy environment. Therefore, the sensed data sensed by the sensor of the wearable device 100 and the data (e.g. calendar event) included in the electronic device 110 can also be determined asynchronous, and alarm is generated to notify the user to find the missing device.

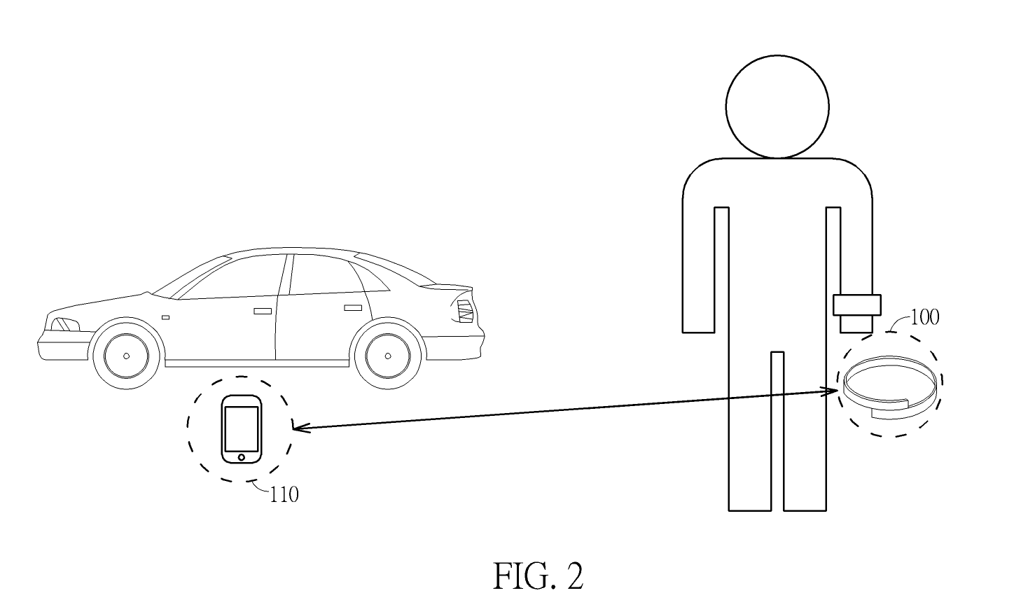

Please refer to FIG. 2, which is a diagram illustrating operations of the wearable device 100 and the electronic device 110 when electronic device 110 is left in a car according to one embodiment of the present invention. Referring to FIG. 2, when user closed the door but his electronic device 110 is left in a car, at this time, the sensed data of at least a portion of the sensors 113-118 of the electronic device 110 may be asynchronous with the sensed data of at least a portion of the sensors 103-108 of the wearable device 100. For example, the sensed data of the accelerometer 113, the noise sensor 114, the ambient light sensor 116 and the barometer 117 of the electronic device 110 may be asynchronous with the sensed data of the accelerometer 103, the noise sensor 104, the ambient light sensor 106 and the barometer 107 of the wearable device 100. In this embodiment, only when both the at least two comparison results indicate that the sensed data of the wearable device and the sensed data of the electronic device are asynchronous, the wearable device 100 determines that the electronic device 110 is not in the aware status of the wearable device 100, and the wearable device 100 notifies the user by vibration or audible alarm, and/or the wearable device 110 may also transmit a control signal to the electronic device 110 to trigger the electronic device 110 to notify the user by vibration or audible alarm or flash.

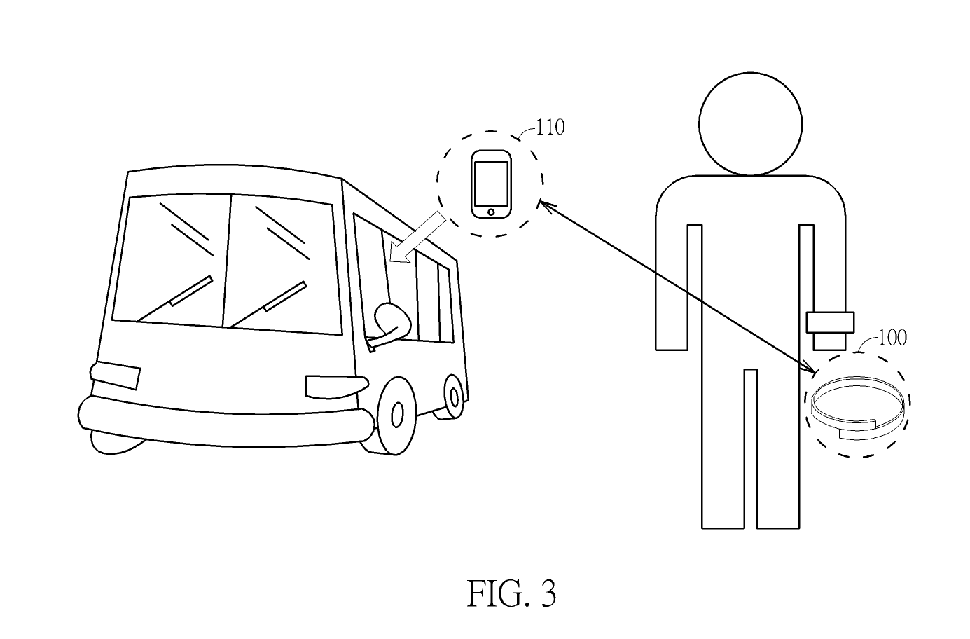

Please refer to FIG. 3, which is a diagram illustrating operations of the wearable device 100 and the electronic device 110 when electronic device 110 is left on a bus according to one embodiment of the present invention. Referring to FIG. 3, when user left the bus but his electronic device 110 is left on the bus, at this time, the sensed data of at least a portion of the sensors 113-118 of the electronic device 110 may be asynchronous with the sensed data of at least a portion of the sensors 103-108 of the wearable device 100. For example, the sensed data of the ambient light sensor 116 and the pedometer 118 of the electronic device 110 may be asynchronous with the sensed data of the ambient light sensor 106 and the pedometer 108 of the wearable device 100. In this embodiment, only when the comparison results indicate that the sensed data of the ambient light sensor 106 and the pedometer 108 of the wearable device 100 and the sensed data of the ambient light sensor 116 and the pedometer 118 of the electronic device 110 are asynchronous, the wearable device 100 determines that the electronic device 110 is not in the aware status of the wearable device 100, and the wearable device 100 notifies the user by vibration or audible alarm, and/or the wearable device 110 may also transmit a control signal to the electronic device 110 to trigger the electronic device 110 to notify the user by vibration or audible alarm or flash.

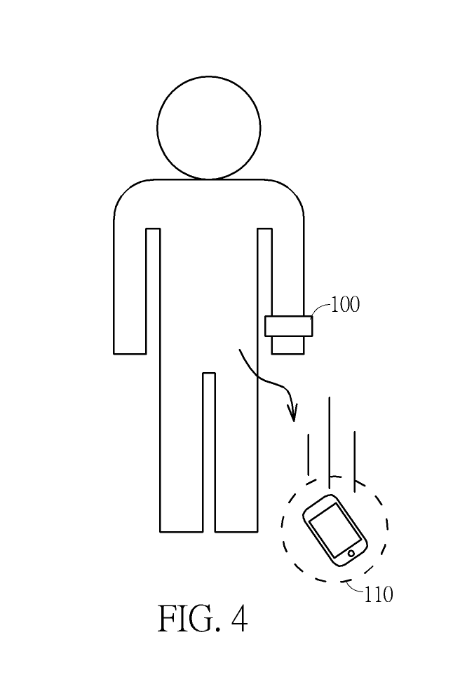

Please refer to FIG. 4, which is a diagram illustrating operations of the wearable device 100 and the electronic device 110 when the electronic device 110 is falling on the ground according to one embodiment of the present invention. Referring to FIG. 4, the electronic device 110 is falling on the ground, at this time, the sensed data of the accelerometer 113 of the electronic device 110 may be asynchronous with the sensed data of the accelerometer 103 of the wearable device 100. In this embodiment, when the comparison results indicate that the sensed data of the accelerometer 113 of the wearable device 100 and the sensed data of the accelerometer 113 of the electronic device 110 are asynchronous, the wearable device 100 determines that the electronic device 110 is not in the aware status of the wearable device 100, and the wearable device 100 notifies the user to get it back in time.

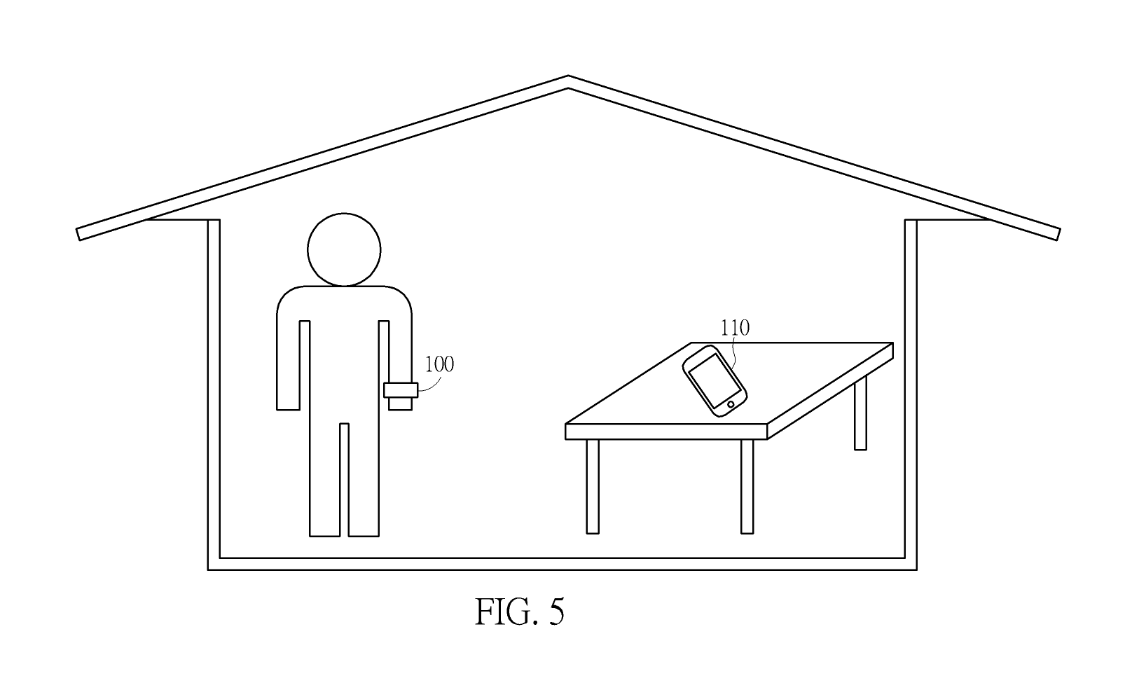

Please refer to FIG. 5, which is a diagram illustrating operations of the wearable device 100 and the electronic device 110 when the wearable device 100 and the electronic device 110 are at home according to one embodiment of the present invention. When the user is in the house, although the sensed data of the sensors of the electronic device 110 and the sensed data of the sensors of the wearable device 110 may be partially asynchronous, the electronic device 110 should be regarded as in the aware status. Therefore, in this embodiment, the control unit 101 may determine whether both the wearable device 100 and the electronic device 110 are at home according to one of the comparison results; and when the control unit 101 determines that both the wearable device 100 and the electronic device 110 are at home, the wearable device 100 determines that the electronic device 110 is in the aware status no matter whether the other comparison results indicate whether the sensed data of the wearable device 100 and the electronic device 110 are synchronous or not.

In the embodiment shown in FIG. 5, the control unit 101 may determine whether both the wearable device 100 and the electronic device 110 are at home by comparing WiFi information of the wearable device 100 with WiFi information of the electronic device 110. In detail, the electronic device 110 may obtain the WiFi information such as sensed access points (APs) or a sensed Beacon (basically, Beacon technology can offer information related to location) sensed by an antenna included in the wireless communication unit 112, and the electronic device 110 transmits the WiFi information to the wearable device 100 for comparing with sensed access points (APs) or a sensed Beacon sensed by an antenna included in the wireless communication unit 102 to generate a specific comparison result. When the specific comparison result indicates that the WiFi information of the wearable device and the electronic device is synchronous (e.g. both the wearable device 100 and the electronic device 110 sense a special AP or Beacon), the wearable device 100 determines that the electronic device 110 is in the aware status no matter whether the other comparison results indicate whether the sensed data of the wearable device 100 and the electronic device 110 are synchronous or not.

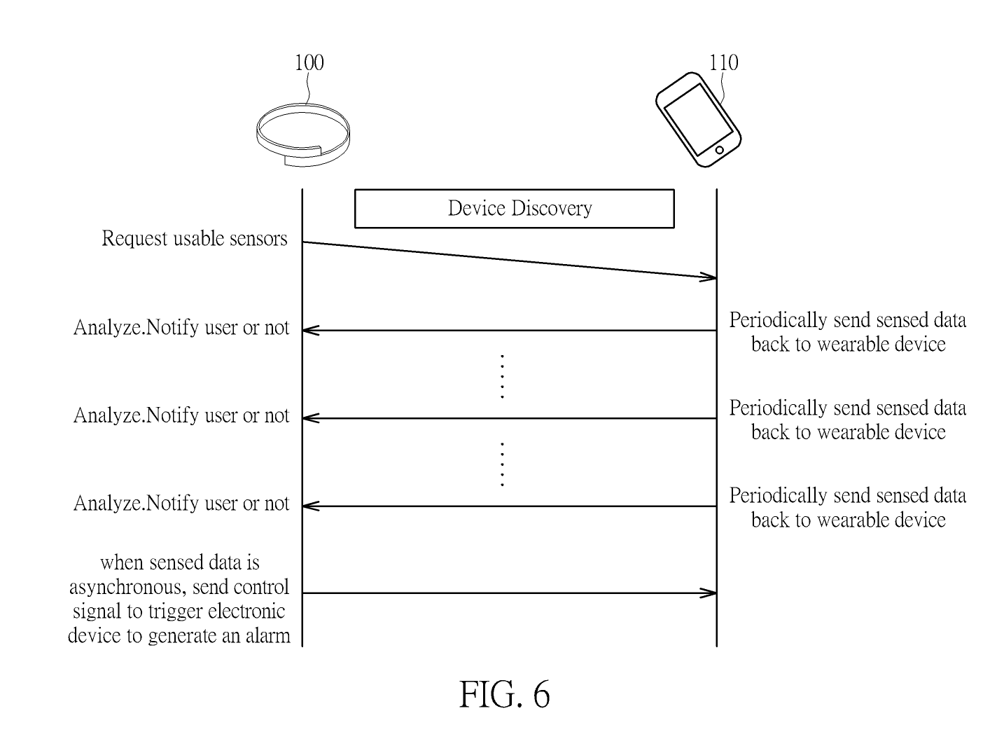

Please refer to FIG. 6, which is a diagram illustrating operations of the wearable device 100 and the electronic device 110 when it is in a device discovery process according to one embodiment of the present invention. As shown in FIG. 6, in the device discovery process, the wearable device 100 sends a request signal to the electronic device 110 to request the usable sensors in the electronic device 110, then the electronic device 110 periodically transmits the sensed data of the usable sensors to the wearable device 100, and the wearable device 100 analyzes the received sensed data to determine whether to notify the user or not. In addition, when the wearable device 100 determines that the sensed data is asynchronous (i.e. the electronic device 110 is not in the aware status), the wearable device 100 may generate an alarm and/or the wearable device 100 transmits a control signal to trigger the electronic device to generate an alarm.

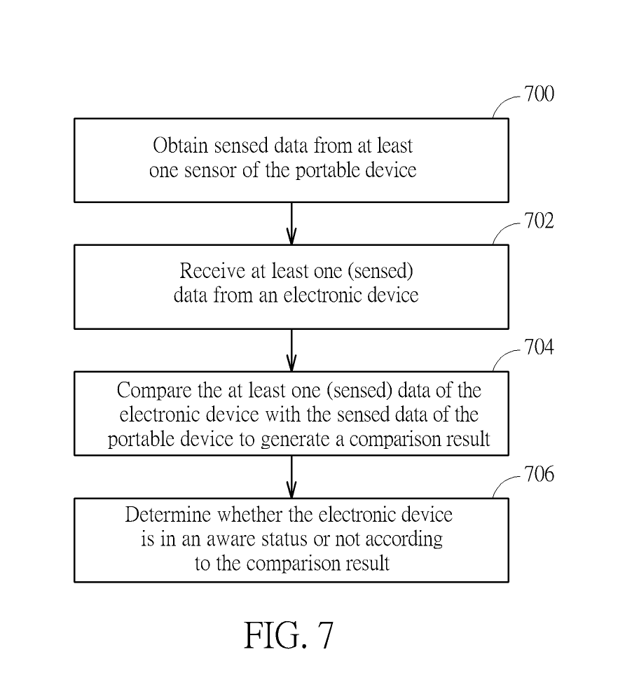

Please refer to FIG. 7, which is a flowchart of a control method of a portable device (such as a wearable device, a mobile phone, tablet device . . . and so on) according to one embodiment of the present invention. Referring to FIG. 1 and FIG. 7, the flow is described as follows.

Step 700: obtain sensed data from at least one sensor of the portable device.

Step 702: receive at least one (sensed) data from an electronic device.

Step 704: compare the at least one (sensed) data of the electronic device with the sensed data of the portable device to generate a comparison result.

Step 706: determine whether the electronic device is in an aware status or not according to the comparison result.

In another embodiment, the electronic device 110 is further arranged to determine whether the sensed data of the wearable device 100 and the electronic device 110 are synchronous or asynchronous, that is the electronic device 110 is arranged to determine whether the electronic device 110 is in the aware status of the wearable device 100 or not. In detail, the wearable device 100 and the electronic device 110 may exchange their sensed data sensed by the sensors 103-108/113-118, and the wearable device 100 and the electronic device 110 determine whether the sensed data of the wearable device 100 and the electronic device 110 are synchronous or asynchronous independently. When one of the wearable device 100 and the electronic device 110 determines that the sensed data of the wearable device 100 and the electronic device 110 are asynchronous, the one of the wearable device 100 and the electronic device 110 makes an alarm, and transmits a control signal to trigger the other one to generate an alarm to notify the user. Moreover, if both the wearable device 100 and the electronic device 110 determine that the sensed data are asynchronous; both of them generate an alarm to notify the user.

It is noted that the control unit 811 within the electronic device 110 is more powerful than the control unit 801 of the wearable device 100, so the electronic device 110 may perform the complicated calculation to determine data asynchronous more accurately.

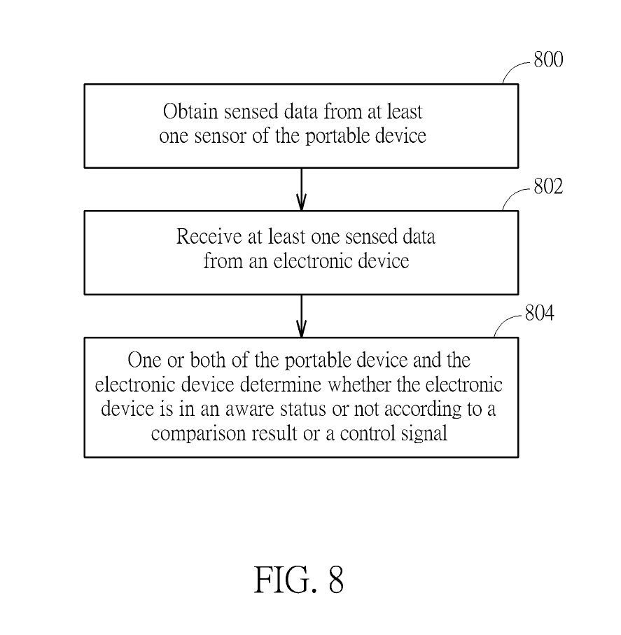

Please refer to FIG. 8, which is a flowchart of a control method of a portable device (such as a wearable device, a mobile phone, tablet device . . . and so on) according to another embodiment of the present invention. Referring to FIG. 1 and FIG. 8, the flow is described as follows.

Step 800: obtain sensed data from at least one sensor of the portable device.

Step 802: receive at least one sensed data from an electronic device.

Step 804: one or both of the portable device and the electronic device determine whether the electronic device is in an aware status or not according to a comparison result or a control signal, wherein the comparison result is generated by the control unit by comparing at least one sensed data of the electronic device with sensed data generated by at least one of the sensors of the portable device; and the control signal represents that the at least one sensed data of the electronic device and the sensed data generated by at least one of the sensors of the wearable device are synchronous or asynchronous.

Briefly summarized, in the wearable device and associated control method of the present invention, the wearable device determines whether the electronic device is under user's control by comparing the sensed data of the wearable device and the electronic device. Therefore, compared with the prior art proximity-based or location-based control method, the determination of the present invention is more accurate.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wearable device, comprising:
a plurality of sensors;
a wireless communication unit, for communicating with an electronic device having a plurality of sensors;
a control unit, for receiving at least one sensed data from the electronic device via the wireless communication unit, and (comparing the at least one sensed data of the electronic device with sensed data generated by at least one of the sensors of the wearable device to generate a comparison result, and determining whether the electronic device is in an aware status or not according to the comparison result).

2. The wearable device of claim 1, wherein the control unit receives a plurality of sensed data generated from at least two sensors of the electronic device via the wireless communication unit, and the control unit compares the plurality of sensed data of the electronic device with sensed data generated by at least two of the sensors of the wearable device to generate a plurality of comparison results, and the control unit determines whether the electronic device is in the aware status according to the comparison results.

3. The wearable device of claim 1, wherein in a device discovery process, the wearable device sends a request signal to the electronic device to request the usable sensors in the electronic device, and the wearable device starts to receive the at least one sensed data from the electronic device periodically.

4. The wearable device of claim 1, wherein both the wearable device and the electronic device have at least two of a barometer sensor, an accelerometer, a noise sensor and an ambient light sensor, and the control unit receives sensed data generated by the at least two of the barometer sensor, the accelerometer, the noise sensor and the ambient light sensor of the electronic device via the wireless communication unit, and the control unit compares the sensed data of the electronic device with sensed data sensed by the sensors of the wearable device to generate at least two comparison results, and only when both the at least two comparison results indicate that the sensed data of the wearable device and the sensed data of the electronic device are asynchronous, the wearable device determines that the electronic device is not in the aware status.

5. The wearable device of claim 1, wherein both the wearable device and the electronic device comprises a pedometer and an ambient light sensor, and the control unit receives sensed data generated by the pedometer and the ambient light sensor of the electronic device via the wireless communication unit, and the control unit compares the sensed data of the electronic device with sensed data sensed by the pedometer and the ambient light sensor of the wearable device to generate two comparison results, and only when both the two comparison results indicate that the sensed data of the wearable device and the sensed data of the electronic device are asynchronous, the wearable device determines that the electronic device is not in the aware status.

6. The wearable device of claim 1, wherein both the wearable device and the electronic device have an accelerometer, and the control unit receives the sensed data generated by the accelerometer of the electronic device via the wireless communication unit, and the control unit compares the sensed data of the electronic device with the sensed data sensed by the accelerometer of the wearable device to generate the comparison result, and when the comparison result indicates that the sensed data of the wearable device and the sensed data of the electronic device are asynchronous, the wearable device determines that the electronic device is not in the aware status.

7. The wearable device of claim 1, wherein the control unit receives a plurality of sensed data generated from at least two sensors of the electronic device via the wireless communication unit, and the control unit compares the plurality of sensed data of the electronic device with sensed data generated by at least two of the sensors of the wearable device to generate a plurality of comparison results, respectively, wherein each comparison result indicates that whether the sensed data sensed by one sensor of the wearable device and the sensed data sensed by one sensor the electronic device is synchronous or asynchronous; and when a specific comparison result of the comparison results indicates that the sensed data of the wearable device and the electronic device is synchronous, the wearable device determines that the electronic device is in the aware status no matter whether the other comparison results indicate whether the sensed data of the wearable device and the electronic device are synchronous or not.

8. The wearable device of claim 7, wherein the control unit receives WiFi information of the electronic device via the wireless communication unit, and the control unit compares the received WiFi information of the electronic device with WiFi information of the wearable device to generate the specific comparison result.

9. The wearable device of claim 8, wherein the WiFi information of the electronic device comprises sensed access points (APs) or a sensed Beacon sensed by an antenna of the electronic device, and the WiFi information of the wearable device comprises sensed access points (APs) or a sensed Beacon sensed by an antenna of the wearable device.

10. The wearable device of claim 1, wherein when the control unit determines that the electronic device is not in the aware status, the wearable device transmits a control signal to the electronic device to trigger an operation of the electronic device.

11. A control method of a portable device, comprising:
obtaining sensed data from at least one sensor of the portable device;
receiving at least one data from an electronic device;
comparing the at least one data of the electronic device with the sensed data of the portable device to generate a comparison result; and
determining whether the electronic device is in an aware status or not according to the comparison result.

12. The control method of claim 11, wherein the comparing step is implemented by a scenario algorithm to compare the sensed data of the portable device with the data of the electronic device.

13. The control method of claim 11, wherein the step of receiving the at least one data from an electronic device comprises:
receiving a calendar event from the electronic device.

14. The control method of claim 11, wherein the obtaining step, the receiving step, the comparing step and the determining step comprises:
obtaining a plurality of sensed data from a plurality of sensors of the portable device;
receiving a plurality of sensed data generated from a plurality of sensors of the electronic device;
comparing the plurality of sensed data of the electronic device with the plurality of sensed data of the portable device to generate a plurality of comparison results; and
determining whether the electronic device is in a aware status or not according to the comparison results.

15. The control method of claim 11, wherein the at least one data from an electronic device is at least one sensed data from the electronic device, and the control method further comprises:
in a device discovery process, sending a request signal to the electronic device to request the usable sensors in the electronic device; and
starting to receive the at least one sensed data from the electronic device periodically.

16. The control method of claim 11, wherein both the portable device and the electronic device comprises a pedometer and an ambient light sensor, and the obtaining step, the receiving step, the comparing step and the determining step comprises:
obtaining sensed data from the pedometer and the ambient light sensor of the of the portable device;
receiving sensed data generated by the pedometer and the ambient light sensor of the electronic device;
comparing the sensed data of the electronic device with the sensed data of the portable device to generate two comparison results; and
only when both the two comparison results indicate that the sensed data of the portable device and the sensed data of the electronic device are asynchronous, determining that the electronic device is not in the aware status.

17. The control method of claim 11, wherein both the portable device and the electronic device have an accelerometer, and the obtaining step, the receiving step, the comparing step and the determining step comprises:
obtaining sensed data from the accelerometer of the of the portable device;
receiving sensed data generated by the accelerometer of the electronic device;
comparing the sensed data of the electronic device with the sensed data of the portable device to generate two comparison results; and
when the comparison result indicates that the sensed data of the portable device and the sensed data of the electronic device are asynchronous, determining that the electronic device is not in the aware status.

18. The control method of claim 11, wherein the obtaining step, the receiving step, the comparing step and the determining step comprises:
obtaining a plurality of sensed data from a plurality of sensors of the portable device;
receiving a plurality of sensed data generated from a plurality of sensors of the electronic device;
comparing the plurality of sensed data of the electronic device with the plurality of sensed data of the portable device to generate a plurality of comparison results, respectively;
determining whether both the portable device and the electronic device are at home according to one of the comparison results; and
when it is determined that both the portable device and the electronic device are at home, determining that the electronic device is in the aware status no matter whether the other comparison results indicate whether the sensed data of the portable device and the electronic device are synchronous or not.

19. A portable device, comprising:
a plurality of sensors;
a wireless communication unit, for communicating with an electronic device having a plurality of sensors;
a control unit, for comparing at least one sensed data of the electronic device with sensed data generated by at least one of the sensors of the portable device; and generating a control signal representing that the at least one sensed data of the electronic device and the sensed data generated by at least one of the sensors of the portable device are synchronous or asynchronous.

20. The portable device of claim 19, wherein when one of the portable device and the electronic device determines that the at least one sensed data of the electronic device and the sensed data generated by at least one of the sensors of the portable device are asynchronous, the one or both of the portable device and the electronic device make an alarm.
